(19) United States
(12) Patent Application Publication
(10) Pub. No.: US 2015/0041707 A1
(43) Pub. Date: Feb. 12, 2015

(54) NEGATIVE ACTIVE MATERIAL FOR SECONDARY BATTERY AND METHOD OF MANUFACTURING THE SAME

(71) Applicant: MK ELECTRON CO., LTD., Gyeonggi-do (KR)

(72) Inventors: Sung Min JEON, Gyeonggi (KR); Jong Soo CHO, Seoul (KR); Hyung Ki AHN, Gyeonggi-do (KR)

(73) Assignee: MK ELECTRON CO., LTD., Gyeonggi-do (KR)

(21) Appl. No.: 14/087,798

(22) Filed: Nov. 22, 2013

(30) Foreign Application Priority Data
Aug. 8, 2013 (KR) 10-2013-0094328
Nov. 15, 2013 (KR) 10-2013-0139318

(51) Int. Cl. H01M 4/36; H01M 4/38; H01M 4/04

(52) U.S. Cl. CPC H01M 4/364; H01M 4/0488; H01M 4/386
USPC 252/182.1; 264/104; 264/430

(57) ABSTRACT

A negative active material for a secondary battery that provides high capacity, high efficiency charging and discharging characteristics includes: a silicon single phase; and a silicon-metal alloy phase by which the silicon single phase is bounded, wherein the negative active material comprises 5 to 30 wt % of nickel, 5 to 30 wt % of titanium, and 40 to 90 wt % of silicon, the negative active material has a first peak of the silicon-metal alloy phase in an X-ray diffraction analysis spectrum, the silicon single phase is finely distributed in the silicon-metal single phase by mechanical alloying, and the first peak resulting from the (501) surface of the silicon-metal alloy phase has a greater value than the first peak resulting from the (501) surface of the silicon-metal alloy phase that is not subjected to the mechanical alloying, by 0.6° to 0.9°.

### RELATED APPLICATIONS

This application claims the benefit of Korean Patent Applications No. 10-2013-0094328, filed on Aug. 8, 2013, and No. 10-2013-0139318, filed on Nov. 15, 2013, in the Korean Intellectual Property Office, the disclosure of which is incorporated herein in its entirety by reference.

### BACKGROUND

1. Field

One or more embodiments of the present invention relates to secondary batteries, and in particular, to negative active materials for a secondary battery, being capable of providing high capacity, high efficiency charging and discharging characteristics, and methods of manufacturing the same.

2. Description of the Related Art

Lithium secondary batteries are used in various applications including power sources for portable electronic products, such as mobile phones or notebook computers, as well as middle- and large-sized power sources, such as hybrid electric vehicles (HEV), or plug-in HEVs. Due to the wide application range and an increasing demand therefor, outer shape and size of batteries are variously changed, and higher capacity, longer lifespan, and higher stability are required than in small batteries according to the related art.

Regarding lithium secondary batteries, materials that enable intercalation and deintercalation of lithium ions are used in a negative electrode and a positive electrode, and a porous separator is disposed between the positive electrode and the negative electrode, and then, an electrolytic solution is added thereto to complete the lithium secondary batteries, wherein at the negative electrode and the positive electrode, oxidation and reduction occurs due to intercalation and deintercalation of lithium ions, thereby generating or consuming electricity.

Graphite, which is widely used as a negative active material for a lithium secondary battery, has a layered structure, which is very suitable for intercalation and deintercalation of lithium ions. Although graphite has, in theory, a capacity of 372 mAh/g, alternative electrodes to an electrode using graphite are required due to the increasing demand for high-capacity lithium batteries. In this regard, research into, for use as a high-capacity negative active material, how to commercialize an electrode active material that forms an electrochemical alloy with lithium ions, such as silicon (Si), tin (Sn), antimony (Sb), or aluminum (Al) is actively performed. However, when Si, Sn, Sb, and Al are charged or discharged due to the electrochemical alloy formation with lithium, a volumetric increase or decrease may occur, and the volumetric change according to charging and discharging may cause deterioration in cyclic characteristics of an electrode including Si, Sn, Sb, and Al as an active material. Also, the volumetric change may cause cracks on the surface of an electrode active material, and when the cracks are continually formed, the surface of an electrode is fragmented, further deteriorating cyclic characteristics.

### SUMMARY

An embodiment of the present invention provides negative active materials for a secondary battery, being capable of providing high capacity, high efficiency charging and discharging characteristics, and a method of preparing the same.

An embodiment of the present invention provides methods of preparing the negative active materials for a secondary battery.

Additional aspects will be set forth in part in the description which follows and, in part, will be apparent from the description, or may be learned by practice of the presented embodiments.

According to one or more embodiments of the present invention, a negative active material includes: a silicon single phase; and a silicon-metal alloy phase by which the silicon single phase is bounded, wherein the negative active material includes 5 to 30 wt % of nickel, 5 to 30 wt % of titanium, and 40 to 90 wt % of silicon, the negative active material has a first peak of the silicon-metal alloy phase in an X-ray diffraction analysis spectrum, and the first peak results from a (501) surface of Ni₄Si₇Ti₄ and appears at about 40.3±0.15 degrees (°).

In exemplary embodiments, the silicon single phase may be finely distributed in the silicon-metal single phase by mechanical alloying, and the first peak resulting from the (501) surface of the silicon-metal alloy phase has a greater value than the first peak resulting from the (501) surface of the silicon-metal alloy phase that is not subjected to the mechanical alloying, by about 0.6° to about 0.9°.

In exemplary embodiments, the first peak resulting from the (501) surface of the silicon-metal alloy phase may have a greater value than the first peak resulting from the (501) surface of the silicon-metal alloy phase that is not subjected to the mechanical alloying, by about 0.7° to about 0.8°.

In exemplary embodiments, the first peak resulting from the (501) surface of the silicon-metal alloy phase may shift more on the right hand side in X-ray diffraction analysis spectrum than the first peak resulting from the (501) surface of the silicon-metal alloy phase that is not subjected to the mechanical alloying by about 0.6° to about 0.9°, due to shrinking of a lattice in a direction perpendicular to the (501) surface by performing mechanical alloying including high energy milling.

In exemplary embodiments, the first peak resulting from the (501) surface of the silicon-metal alloy phase may shift more on the right hand side in X-ray diffraction analysis spectrum than the first peak resulting from the (501) surface of the silicon-metal alloy phase that is not subjected to the mechanical alloying by about 0.7° to about 0.8°, due to shrinking of a lattice in a direction perpendicular to the (501) surface by performing mechanical alloying including high energy milling.

In exemplary embodiments, the negative active material may include 10 to 30 wt % of nickel, 10 to 30 wt % of titanium, and 40 to 80 wt % of silicon.

In exemplary embodiments, a size of the silicon single phase calculated from the X-ray diffraction analysis spectrum is smaller than about 20 nm.

According to one or more embodiments of the present invention, a method of preparing a negative active material that is used in a secondary battery and includes a silicon-metal alloy powder, includes melting silicon and metal to form a molten mixture; solidifying the molten mixture by rapid cooling to form a ribbon-shape rapid cooling solidification product; and milling the rapid cooling solidification product by using a high energy milling apparatus so that alloy powder is formed and simultaneously, a silicon single phase is fragmented in the alloy powder, wherein a size of the silicon single phase in the alloy powder is smaller than about 50 nm.

In exemplary embodiments, the high energy milling apparatus may include at least one selected from a high energy ball mill apparatus, an agitating ball mill apparatus, an oil-based ball mill apparatus, and a vibration ball mill apparatus.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart illustrating a method of preparing a negative active material according to embodiments of the present invention;

FIG. 2 shows transmission electron microscopy (TEM) images of ribbon alloys formed by rapid cooling solidification according to an embodiment of the present invention;

FIG. 3 shows TEM images of negative active material powder that is milled and finely alloyed by mechanical alloying according to embodiments of the present invention;

FIG. 4 shows scanning electron microscopy (SEM) images of negative active material powder that is milled and finely alloyed by mechanical alloying according to embodiments of the present invention;

FIG. 5 shows SEM images of negative active material powder that is milled by ball-milling according to Comparative Example 8;

FIGS. 6A and 6B are graphs of X-ray diffraction patterns of negative active material powder that is milled and finely alloyed by mechanical alloying according to embodiments of the present invention;

FIGS. 7A to 7C show graphs showing electrochemical performance of negative active material powder that is milled and finely alloyed by mechanical alloying according to embodiments of the present invention; and

FIGS. 8 to 10 show graphs showing electrochemical performance of negative active material powder that is milled and finely alloyed by mechanical alloying according to other embodiments of the present invention.

### DETAILED DESCRIPTION

The present inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the concept of the inventive concept to those of ordinary skill in the art. In the drawings, the thicknesses of layers and regions are exaggerated for clarity. As used herein, the term “and/or” includes any and all combinations of one or more of the associated listed items. Through the specification, like reference numerals denote like elements. Furthermore, in the drawings, various elements and regions are schematically illustrated. Accordingly, the inventive concept is not limited to the relative sizes and intervals illustrated in the attached drawings. In embodiments of the present invention, at % (atom %) indicates a percentage point of the number of atoms of a corresponding component in the total number of atoms constituting an alloy.

A negative active material for a secondary battery according to an embodiment of the present invention includes a silicon single phase, and a silicon-metal alloy phase that bounds the silicon single phase. The negative active material includes 5 to 30 wt % of nickel, 5 to 30 wt % of titanium, and 40 to 90 wt % of silicon, wherein the negative active material has a first peak of the silicon-metal alloy phase in an X-ray diffraction spectrum, and the first peak is a peak that is located at 40.3±0.15 degrees (°) and resulting from a (501) surface of Ni₄Si₇Ti₄. The silicon single phase is finely distributed inside the silicon-metal alloy phase by using a mechanical alloy method, and the first peak resulting from the (501) surface of the silicon-metal alloy phase may have a greater value than a peak resulting from the (501) surface of the silicon-metal alloy phase which is not subjected to the mechanical alloying by about 0.6° to about 0.9°.

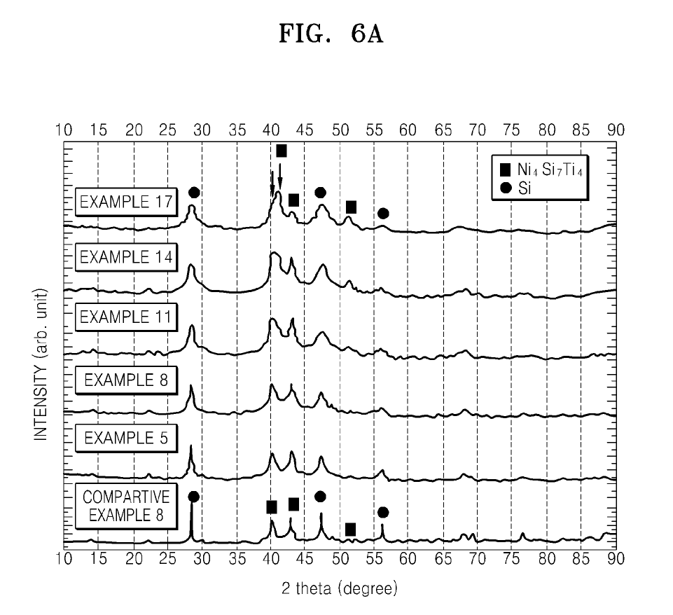

According to an embodiment of the present invention, the location of the first peak of the silicon-metal alloy phase is associated with a fine structure of the negative active material. For example, when the first peak is greater by about 0.6° to about 0.9° than that when the mechanical alloying is not performed (that is, the location of the first peak is shifted on the right hand side), the crystal structure of the silicon-metal alloy phase may be shrunken in a crystal direction corresponding to the first peak. In particular, as the first peak resulting from a (501) surface of Ni₄Si₇Ti₄ shifts toward a greater value, the silicon single phase inside the negative active material is more uniformly and more finely fragmented, and thus, lifespan characteristics and charging/discharging capacitance characteristics of the negative active material may improve. The relationship between the fine structure and the location of the first peak will be described in detail in connection with FIGS. 6A and 6B.

According to an embodiment of the present invention, the first peak resulting from the (501) surface of the silicon-metal alloy phase has a greater value than the peak of the (501) surface of the silicon-metal alloy phase that is not subjected to the mechanical alloy by about 0.6° to about 0.9°, and the negative active material may have excellent lifespan characteristics and excellent charging/discharging capacitance characteristics.

For example, when the first peak resulting from the (501) surface of the silicon-metal alloy phase has a greater value by 0.7° to 0.8° than the peak of the (501) surface of the silicon-metal alloy phase that is not subjected to the mechanical alloy, the negative active material may have excellent lifespan characteristics.

According to an embodiment of the present invention, the negative active material may include a silicon single phase; and a silicon-metal alloy phase, wherein a metal of the silicon-metal alloy phase includes at least one metal element selected from the group consisting of titanium, nickel, copper, iron, manganese, aluminum, chromium, cobalt, and zinc. For example, the negative active material may include 5 to 30 wt % of nickel, 5 to 30 wt % of titanium, and 40 to 90 wt % of silicon.

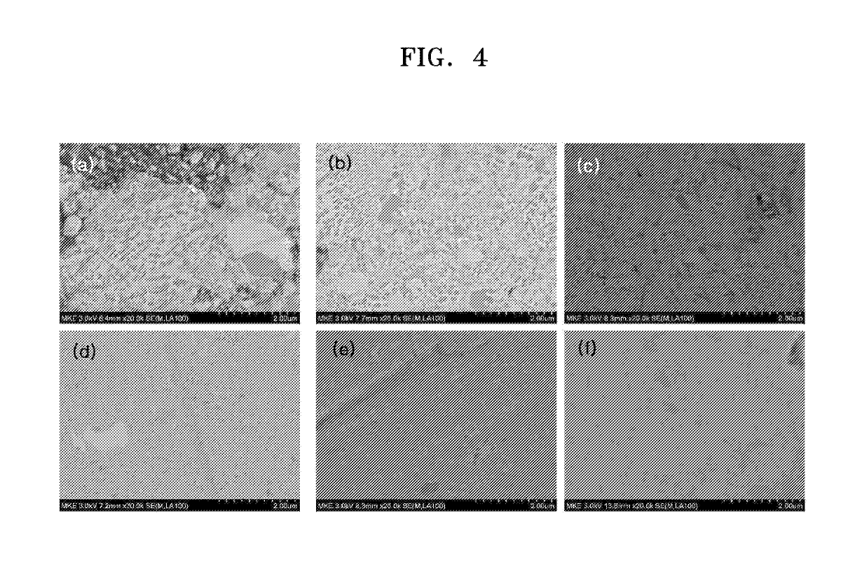

In the negative active material according to embodiments of the present invention, a grain size of the silicon single phase calculated by X-ray diffraction analysis may be smaller than 20 nm. Also, a grain size of the silicon-metal alloy phase calculated according to X-ray diffraction analysis may be smaller than 10 nm. For example, when the grain size of the silicon single phase is smaller than 20 nm, the silicon-metal alloy, which is a matrix, may act as a buffer layer that buffers a volumetric change of the silicon single phase due to intercalation/deintercalation of lithium particles during charging and discharging, and furthermore, may prevent cracks and damage on a secondary battery caused by volumetric change. Accordingly, the negative active material may have excellent lifespan characteristics such as capacity retention ratio. The distribution of grain sizes of the silicon single phase and the silicon-metal alloy phase calculated by X-ray diffraction analysis will be described in detail with reference to FIG. 4.

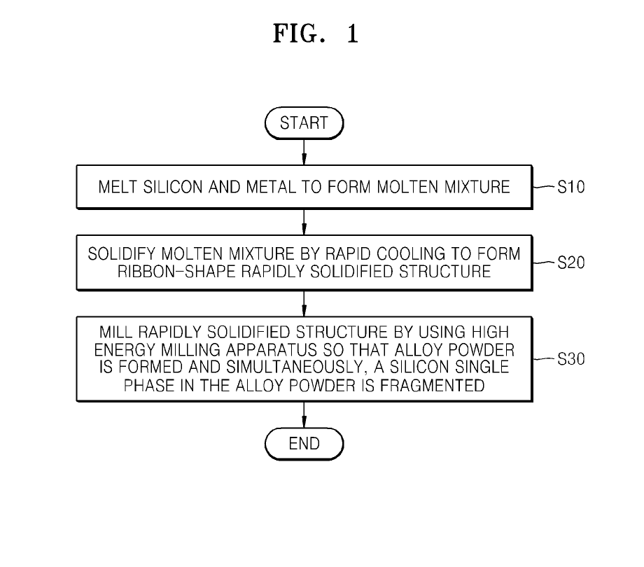

FIG. 1 is a flowchart illustrating a method of preparing a negative active material according to embodiments of the present invention.

Referring to FIG. 1, silicon and a metal element are melted to form a mother alloy molten mixture (operation S10). The metal element may be at least one metal element selected from titanium, nickel, copper, iron, manganese, aluminum, chromium, cobalt, and zinc.

For example, silicon and a metal element are added to a melting container, and then, the melting container is heated by arc-melting or high-frequency melting to form a mother alloy molten mixture. In this regard, to prevent undesired oxidation of the molten mixture, the molten mixture may be formed in vacuum atmosphere, or inert gas atmosphere, such as argon atmosphere or nitrogen atmosphere. For example, the heating temperature of the melting container may be maintained at a temperature that is greater than the melting point of the mother alloy by at least 200° C., and accordingly, the mother alloy in the melting container may be sufficiently melted and mixed.

Then, the molten mixture is rapidly cooled to form a ribbon alloy in which the coarse silicon single phase is distributed inside the silicon-metal alloy phase (operation S20).

An example of a process for forming a ribbon alloy by using a melt spinner will be described in detail. The molten mixture of the mother alloy is discharged from the melting container to a top portion of a cooling roll that rapidly rotates, and the molten mixture of the mother alloy contacting the cooling roll rapidly cools, thereby forming a ribbon alloy. For example, the cooling speed of the ribbon alloy may be 10³° C./sec to 10^{7°} C./sec, and the cooling speed may vary according to the rotational speed, material, and temperature of the cooling roll. Also, when the molten mixture of the mother alloy cools, a coarse silicon single phase may be distributed inside the silicon-metal alloy phase. In particular, a portion of the ribbon alloy that directly contacts the cooling roll, due to the rapid cooling speed, may be solidified in such a way that the silicon single phase is solidified in a state of being finely precipitated inside the silicon-metal alloy phase. However, a portion of the ribbon alloy that does not directly contact the cooling roll (that is, a portion of the ribbon alloy away from the portion directly contacting the cooling roll) may cool at a speed that is lower than that of the contact portion, and inside the silicon-metal alloy phase, the silicon single phase may be solidified in a state of being coarsely precipitated. Accordingly, the grain size and distribution of the silicon single phase in the ribbon alloy may not be uniform.

Examples of the rapid cooling of the molten mixture include splat quenching, rotating drum quenching, double-roller quenching, chill block melt spinning, inside casting, melt extraction method, pendant drop melt extraction method, rotating electrode, electric explosion, and gas atomization, but are not limited thereto.

Thereafter, the ribbon alloy is milled and alloyed by using a mechanical alloying method to form the negative active material powder in which silicon single phase is finely distributed inside a silicon-metal alloy phase (operation S30).

According to an embodiment of the present invention, the ribbon alloy and milling balls are introduced into a milling container to mill and alloy the ribbon alloy in a short time with application of high energy. Since the ribbon alloy is milled and alloyed by mechanical alloying, the fine silicon single phase may be uniformly distributed in the negative active material powder, being bounded by the silicon-metal alloy phase. The ribbon alloy may be milled into powder alloy having a particle diameter of a few micrometers or less, and also, silicon single phase particles may be fragmented. In particular, powder alloy particles that are milled due to impacts caused by rotation and collision of milling balls may be repeatedly subjected to forging, cold pressure welding, and crushing. Accordingly, powder alloy particles are finely mixed, and due to the driving force from the increase in interfacial energy, the solid phase diffusion of atoms is promoted and fine alloying may occur. Thus, the coarse silicon single phase which is formed in the non-contact portion of the ribbon alloy may be changed into fine silicon single phase, and the fine silicon single phase in the negative active material powder may be uniformly distributed. For example, in the negative active material powder formed by milling and alloying, the silicon single phase of a particle diameter of 50 nm or less may be uniformly distributed.

In exemplary embodiments, examples of a high energy milling apparatus includes a high energy ball mill apparatus, an agitating ball mill apparatus, an oil-based ball mill apparatus, or a vibration ball mill apparatus, but are not limited thereto.

According to an embodiment of the present invention, since the ribbon alloy is milled and alloyed by mechanical alloying, the fine silicon single phase may be uniformly distributed in the negative active material powder, being bounded by the silicon-metal alloy phase. The negative active material may have excellent lifespan characteristics and electrochemical characteristics.

Experimental examples for preparing a negative active material powder for a secondary battery according to an embodiment of the present invention will be described in detail.

Table 1 below shows mother alloy formation conditions and milling conditions of a negative active material for a secondary battery according to an embodiment of the present invention. In detail, the negative active material may include 17 wt % titanium, 17 wt % nickel, and the balance of silicon (in Table 1, represented by 66Si-17Ti-17Ni), 17.5 wt % titanium, 17.5 wt % nickel, and the balance of silicon (represented by 65Si-17.5Ti-17.5Ni), 16 wt % titanium, 16 wt % nickel, and the balance of silicon (represented by 68Si-16Ti-16Ni), titanium 15 wt %, nickel 15 wt % and the balance of silicon (represented by 70Si-15Ti-15Ni), or titanium 14 wt %, nickel 14 wt % and the balance of silicon (represented by 72Si-14Ti-14Ni). Regarding mother alloy formation conditions, a mother alloy was formed by rapid cooling solidification (Examples 1 to 18, Comparative Examples 1 to 13), powdering (Comparative Examples 14 and 15), and ingot (Comparative Example 16). Also, the mother alloy was milled by low energy milling, such as ball milling (Comparative Examples 1, 5-9 and 14), high energy milling (Comparative Examples 1 to 18), air-jet milling (Comparative Examples 3 and 10), and attrition milling (Comparative Examples 4, and 11 to 13).

TABLE 1

| | | Mother alloy | Kind of | Milling | | Detailed |
|---|---|---|---|---|---|---|
| | Composition | formation | milling | time | | conditions |
| Comparative | 66Si—17Ti—17Ni | Rapid cooling | Low energy | 48 | hr | 200 rpm |
| Example 1 | | solidifying | (ball mill) | | | |
| Comparative | 70Si—15Ti—15Ni | (M/S) | Pebble mill | 6 | days | 85 rpm |
| Example 2 | | | | | | |
| Comparative | 66Si—17Ti—17Ni | | Air jet mill | 1 | h | 0.7 MPa pressure |
| Example 3 | | | | | | |
| Comparative | 68Si—16Ti—16Ni | | Attrition mill | 1.5 | h | 300 rpm |
| Example 4 | | | | | | |
| Comparative | 65Si—17.5Ti—17.5Ni | | Low energy | 48 | hr | 200 rpm |
| Example 5 | | | (ball mill) | | | |
| Comparative | 66Si—17Ti—17Ni | | | | | 200 rpm, followed by |
| Example 6 | | | | | | plasma coating |
| Comparative | 68Si—16Ti—16Ni | | | | | 200 rpm |
| Example 7 | | | | | | |
| Comparative | 70Si—15Ti—15Ni | | | | | |
| Example 8 | | | | | | |
| Comparative | 72Si—14Ti—14Ni | | | | | |
| Example 9 | | | | | | |
| Example 1 | 68Si—16Ti—16Ni | | High energy | 0.5 | h | 550-45 sec/ |
| Example 2 | 70Si—15Ti—15Ni | | | | | 350 rpm-15 sec |
| Example 3 | 72Si—14Ti—14Ni | | | | | |
| Example 4 | 68Si—16Ti—16Ni | | | 1 | h | |
| Example 5 | 70Si—15Ti—15Ni | | | | | |
| Example 6 | 72Si—14Ti—14Ni | | | | | |
| Example 7 | 68Si—16Ti—16Ni | | | 2 | h | |
| Example 8 | 70Si—15Ti—15Ni | | | | | |
| Example 9 | 72Si—14Ti—14Ni | | | | | |
| Example 10 | 68Si—16Ti—16Ni | | | 4 | h | |
| Example 11 | 70Si—15Ti—15Ni | | | | | |
| Example 12 | 72Si—14Ti—14Ni | | | | | |
| Example 13 | 68Si—16Ti—16Ni | | | 6 | h | |
| Example 14 | 70Si—15Ti—15Ni | | | | | |
| Example 15 | 72Si—14Ti—14Ni | | | | | |
| Example 16 | 68Si—16Ti—16Ni | | | 8 | h | |
| Example 17 | 70Si—15Ti—15Ni | | | | | |
| Example 18 | 72Si—14Ti—14Ni | | | | | |
| Comparative | 66Si—17Ti—17Ni | | Air jet mill | 1 | h | 0.7 MPa pressure, |
| Example 10 | | | | | | followed by etching |
| Comparative | 65Si—17.5Ti—17.5Ni | | Attrition mill | 1.5 | h | 300 rpm |
| Example 11 | | | | | | |
| Comparative | 66Si—17Ti—17Ni | | | | | |
| Example 12 | | | | | | |
| Comparative | 70Si—15Ti—15Ni | | | | | |
| Example 13 | | | | | | |
| Comparative | 70Si—15Ti—15Ni | powder | Low energy | 6 | days | 200 rpm |
| Example 14 | | | | | | |
| Comparative | 70Si—15Ti—15Ni | | High energy | 8 | h | 550-45 sec/ |
| Example 15 | | | | | | 350 rpm-15 sec |
| Comparative | 70Si—15Ti—15Ni | Ingot | High energy | 8 | h | |
| Example 16 | | | | | | |

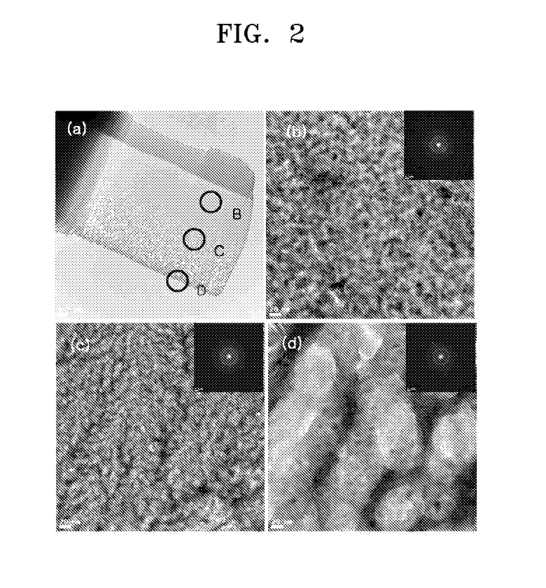

FIG. 2 shows transmission electron microscopy (TEM) images of a ribbon alloy formed by rapid cooling solidifying according to exemplary examples of the present invention. In detail, (a) of FIG. 2 is a cross-sectional image of the ribbon alloy having a contact side (indicated as “wheel side”) and a non-contact side (indicated as “free side”), and (b), (c), and (d) of FIG. 2 are enlarged cross-sectional images of portions B, C, and D of (a).

Referring to FIG. 2, it is confirmed that the ribbon alloy has a contact side contacting a cooling roll and a non-contact side disposed opposite to the contact side, and the contact side and the non-contact side have different micro structures. In particular, referring to (b) of FIG. 2, in a portion of the ribbon alloy adjacent to the contact side, the silicon-metal alloy phase (black) constitutes a matrix and the silicon phase (white) is uniformly distributed in small sizes. However, as closer to the non-contact side, the ribbon alloy has the greater silicon single phase (see (c) of FIG. 2). In a portion of the ribbon alloy adjacent to the non-contact side, the silicon single phase becomes coarse, having a very large particle diameter, and the silicon-metal alloy phase also becomes coarse (see (d) of FIG. 2). That is, as described above, when a high-temperature mother alloy molten mixture is solidified by rapid cooling performed by, for example, melt spinning, the portion of the ribbon alloy that directly contacts the low-temperature cooling roll may be very rapidly solidified and thus, the silicon single phase having small grain sizes may be solidified, being surrounded by the silicon-metal alloy phase. Accordingly, referring to (b) of FIG. 2, the silicon single phase having small sizes precipitates. However, a portion of the ribbon alloy adjacent to the non-contact side, that is, a portion of the ribbon alloy that does not directly contact the cooling roll and is exposed to air may have a longer solidification time than the portion adjacent to the contact side, and during solidification, the silicon single phase grains may grow and become coarse. Accordingly, as shown in (d) of FIG. 2, coarse silicon single phase precipitates.

Also, since the grain size distribution of the silicon single phase may vary according to location of the ribbon alloy, in the ribbon alloy formed by rapid cooling solidification, fine silicon single phase particles and coarse silicon single phase particles may be non-uniformly mixed.

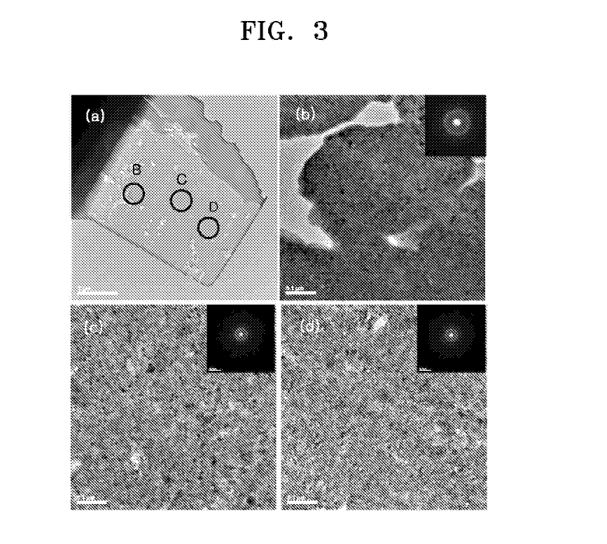

FIG. 3 shows TEM images of negative active material powder that is milled and finely alloyed by mechanical alloying according to an embodiment of the present invention. In detail, (a) of FIG. 3 is a cross-sectional image of negative active material powder, and (b), (c), and (d) are enlarged cross-sectional images of portions B, C, and D of (a).

Referring to FIG. 3, it was confirmed that in all cross-sections of the negative active material powder, the silicon single phase finely precipitates. That is, as described above, when mechanical alloying, such as high energy milling, is performed, the ribbon alloy is milled due to impact energy caused by rotation and collision of the ribbon alloy and the milling ball, and also, powder alloy particles formed by milling may be repeatedly subjected to forging, cold pressure welding, and crushing, thereby promoting diffusion of a solid phase of an atom inside powder alloy particles. As a result, the silicon single phase and the silicon-metal alloy phase may be finely alloyed. The coarse silicon single phase and the coarse silicon-metal alloy phase, which were observed in the ribbon alloy, are fragmented by mechanical alloying, and thus, fine silicon single phase fragments may precipitate inside the silicon-metal alloy phase. Accordingly, the silicon single phase in the negative active material powder may have uniform grain sizes. For example, the silicon single phase in the negative active material powder may have a grain size of less than about 50 nm.

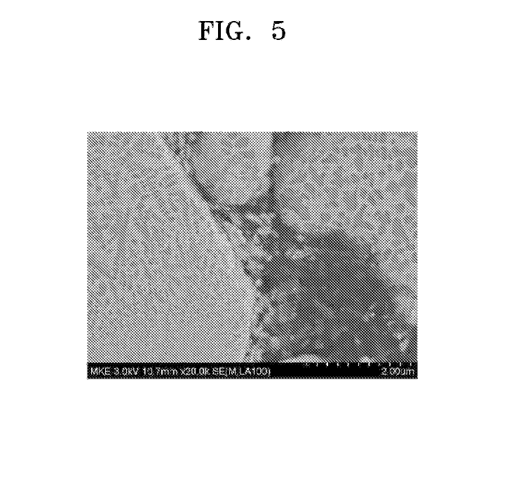

FIG. 4 shows scanning electron microscopy (SEM) images of negative active material powder that is milled and finely alloyed by mechanical alloying according to embodiments of the present invention. FIG. 5 shows a SEM image of a negative active material powder that is milled by ball-milling according to Comparative Example.

FIG. 4 shows micro structure change of negative active material powders that are milled and finely alloyed by high energy milling according to a milling time. In detail, (a) to (f) of FIG. 4 show cross-sectional images of negative active material powders subjected to high energy milling for 0.5, 1, 2, 4, 6, and 8 hours according to Examples 2, 5, 8, 11, 14, and 17, respectively. FIG. 5 is a cross-sectional image of negative active material powder according to Comparative Example 8 in which ball milling is performed for 48 hours.

Referring to FIGS. 4 and 5, the longer the high energy milling time is, the smaller grain size the silicon single phase which precipitates in the negative active material powder has.

In particular, in the case of (a) and (b) of FIG. 4, milling is performed for 0.5 hours and 1 hour respectively, and the silicon single phase (indicated as gray) is formed in the oval or dendrite shape, and bounded by the silicon-metal alloy phase (indicated as white or light gray). In this case, a particle diameter of the silicon single phase may be, for example, tens of nanometer to hundreds of nanometers. Also, some silicon single phases are still coarse and had a grain size of 831 nm and 398 nm (see (b) of FIG. 4).

However, in the case of (d), (e), and (f) of FIG. 4, silicon single phase particles are very small, and it was confirmed that silicon single phase particles are uniformly bounded by the silicon-metal alloy phase. In addition, coarse silicon single phase particles do not exist due to mechanical alloying, and instead, have changed into fine silicon single phase particles.

Table 2 shows crystal grain sizes of Examples explained in connection with FIG. 4. That is, Table 2 shows crystal grain sizes of negative active material powders prepared according to Examples 2, 5, 8, 11, 14, and 17 in which high energy milling is performed for 0.5, 1, 2, 4, 6 and 8 hours, and negative active material powder prepared according to Comparative Example 8 in which ball milling was performed.

The crystal grain sizes are values that are obtained by performing X-ray diffraction analysis on the negative active material powders prepared according to the respective examples and calculation according to Scherrer equation. In Equation (1) below, B(2θ) is an average crystal grain size, K is a shape factor, A is a wavelength of used X-ray, L is a width of a peak where the maximum intensity is in half, that is, a full width at half maximum (FWHM), and θ is Bragg angle.

$$B ( 2 θ ) = \frac{K λ}{L cos θ} \qquad ( 1 )$$

TABLE 2

Crystal grain size (nm)

| Sample No. | Si | Ni₄Si₇Ti₄ |
|---|---|---|
| Comparative | 103 (±0.24) | 11.1 (±0.15) |
| Example 8 | | |
| Example 2 | 27.2 (±0.15) | 8.51 (±0.32) |
| Example 5 | 22.9 (±0.26) | 6.45 (±0.33) |
| Example 8 | 15.8 (±0.26) | 5.54 (±0.33) |
| Example 11 | 7.8 (±0.22) | 4.54 (±0.39) |
| Example 14 | 7.4 (±0.35) | 4.44 (±0.37) |
| Example 17 | 4.6 (±0.11) | 4.64 (±0.55) |

Referring to Table 2, it was confirmed that when the high energy milling time increases, average grain size of the silicon single phase gradually reduces from 27.2 nm (Example 2) to 4.6 nm (Example 17). Also, it was confirmed that the grain size of the silicon-metal alloy phase (corresponding to Ni₄Si₇Ti₄ in Examples) gradually reduces from 8.51 nm (Example 2) to 4.64 nm (Example 17). This result matches with results obtained from the SEM images of FIG. 4.

Also, in the case of the negative active material powder prepared according to Comparative Example 8, the silicon single phase has an average grain size of 103 nm. This is because when low energy milling, such as ball milling, is performed, impact energy supplied is not as sufficient as in Examples 2, 5, 8, 11, 14 and 17 to initiate fine-alloying of the silicon single phase, and thus, during milling of powder, fragmentation and alloying of the silicon single phase may have not occurred.

FIGS. 6A and 6B show graphs of X-ray diffraction pattern for the negative active material powder that is milled and finely alloyed by mechanical alloying according to exemplary examples of the present invention. In detail, FIG. 6A shows X-ray diffraction patterns of negative active material powders prepared according to Examples 5, 8, 11, 14, and 17 in which high energy milling is performed for 1, 2, 4, 6 and 8 hours, and negative active material powder prepared according to Comparative Example 8 in which ball milling was performed. In detail, FIG. 6B shows X-ray diffraction patterns of negative active material powders prepared according to Examples 6, 9, 12, 15, and 18 in which high energy milling is performed for 1, 2, 4, 6 and 8 hours, and negative active material powder prepared according to Comparative Example 9 in which ball milling was performed.

Table 3 shows the location and intensity of the (501) peak of silicon-metal alloy phase obtained from FIGS. 6A and 6B. X-ray diffraction patterns were measured by using D8focus of Bruker Company, and a Cu target (1.5406 Å) was used at a scan speed of 1 second and in a scan unit of 0.019 degrees.

TABLE 3

| | 70Si—15Ti—15Ni | | | 72Si—14Ti—14Ni | | |
|---|---|---|---|---|---|---|
| Milling | | Location of | Intensity of | | location of | Intensity of |
| time | | (501) peak | (501) peak | | (501) peak | (501) peak |
| (hr) | Example No. | (degree) | (arb. unit) | Example No. | (degree) | (arb. unit) |
| 1 | 5 | 40.173 | 3039.216 | 6 | 40.154 | 3474.506 |
| 2 | 8 | 40.232 | 2838.584 | 9 | 40.252 | 2780.68 |
| 4 | 11 | 40.213 | 2691.573 | 12 | 40.311 | 2744.406 |
| | | | | | 40.743 | 2284.258 |
| 6 | 14 | 40.350 | 2584.128 | 15 | 40.350 | 2504.785 |
| | | | | | 40.920 | 2351.618 |
| 8 | 17 | 40.350 | 2300 | 18 | 40.409 | 2424.49 |
| | | 40.881 | 2796.747 | | 40.920 | 2450.284 |
| Ball | Comparative | 40.134 | 3566.202 | Comparative | 40.173 | 3202.523 |
| milling | Example 8 | | | Example 9 | | |

Referring to FIG. 6A and Table 3, when the negative active material includes 15 wt % of nickel, 15 wt % of titanium, and the balance of silicon (corresponding to 70Si-15Ni-15Ti), the longer the high energy milling time is, the peak resulting from the (501) surface of the silicon-metal alloy phase shifts more on the right hand side. In detail, a peak resulting from the (501) surface of Si₇Ti₄Ni₄ that is the silicon-metal alloy phase may appear at about 40.352±0.3 degrees. This is confirmed by Comparative Example 8, in which ball milling is performed for 48 hours, and a peak resulting from the (501) surface appears at 40.134 degrees.

However, in the case of Examples 5, 8, 11, and 14 in which high energy milling is performed, the peak resulting from the (501) surface gradually shifts on the right hand side at about 40.173, 40.232, 40.213, and 40.350 (that is, the larger value). Also, in the case of Comparative Example 17, there are two split peaks resulting from (501) surface (indicated by an arrow in FIG. 6A): a first peak appears at about 40.350 degrees, and a second peak appears at about 40.881 degrees. The first and second peaks all shift more on the right hand side than that of Comparative Example 8.

Such results were also obtained from a negative active material including 14 wt % of nickel, 14 wt % of titanium and the balance of silicon (corresponding to 72Si-14Ni-14Ti). The second peak resulting from the (501) surface of Si₇Ti₄Ni₄ that is the silicon-metal alloy phase may appear at about 40.83±0.1 degrees.

Referring to FIG. 6B and Table 3, in the case of Examples 6 and 9 in which high energy milling is performed, the peaks resulting from the (501) surface gradually shift on the right hand side at about 40.154 and 40.252 degrees (that is, the greater value). Also, Examples 12, 15, and 18 have two split peaks respectively (indicated as an arrow in FIG. 6B), and a first peak of Example 12 is 40.311 degrees and a second peak of Example 12 is 40.743 degrees, and a first peak of Example 15 is 40.350 degrees and a second peak of Example 15 is 40.920 degrees, and a first peak of Example 18 is 40.409 degrees and a second peak of Example 18 is 40.920 degrees. These peaks all shift more on the right hand side than a peak (appearing at 40.154 degrees) resulting from the (501) surface of Comparative Example 9, in which ball milling is performed for 48 hours.

This shift of the peak resulting from the (501) surface may be due to the fact that silicon single phase is fragmented by high energy milling, thereby causing a stress to the lattice of the silicon-metal alloy phase that constitutes a matrix resulting in a distortion. For example, the silicon single phase has a diamond cubic crystal structure (space group: Fd3(227)), and Si₇Ti₄Ni₄ has a tetragonal crystal structure (space group: I4/mmm(139)). In this regard, from the location of the peak resulting from the (501) surface of Si₇Ti₄Ni₄ phase, a distance between (501) surfaces (that is, the distance in a direction perpendicular to the (501) surface) may be calculated, and the larger degree the peak resulting from the (501) surface has, the smaller the distance between (501) surfaces of Si₇Ti₄Ni₄ phase is. According to embodiments of the present invention, silicon single phase and silicon-metal alloy phase are fragmented by high energy milling, thereby causing a stress inside the silicon-metal alloy phase, and thus, the lattice may shrink in a direction perpendicular to the (501) surface. Accordingly, as a high energy milling time increases, the (501) peak may shift to a greater degree.

The negative active material according to embodiments of the present invention may have a peak resulting from the (501) surface of silicon-metal alloy phase of 40.3±0.15 degrees (°). In addition, the peak resulting from the (501) surface may shift more on the right hand side by about 0.6° to about 0.9° than the peak resulting from the (501) surface of the silicon-metal alloy phase that is not subjected to the mechanical alloying, for example, high energy milling. For example, the peak resulting from the (501) surface may shift more on the right hand side by about 0.7° to about 0.8° than the peak resulting from the (501) surface of the silicon-metal alloy phase that is not subjected to the mechanical alloying, for example, high energy milling.

In the negative active material according to embodiments of the present invention, when alloy powder is formed by high energy milling, the silicon single phase may be fragmented, applying stress to the silicon-metal alloy phase. Accordingly, when the peak resulting from the (501) surface shifts more on the right hand side by about 0.6° to about 0.9° than the peak resulting from the (501) surface of the silicon-metal alloy phase that is not subjected to high energy milling, excellent lifespan characteristics and excellent charging/discharging capacitance characteristics may be obtained. For example, when the peak resulting from the (501) surface shifts more on the right hand side by about 0.7° to about 0.8° than the peak resulting from the (501) surface of the silicon-metal alloy phase that is not subjected to high energy milling, more excellent lifespan characteristics and more excellent charging/discharging capacitance characteristics may be obtained.

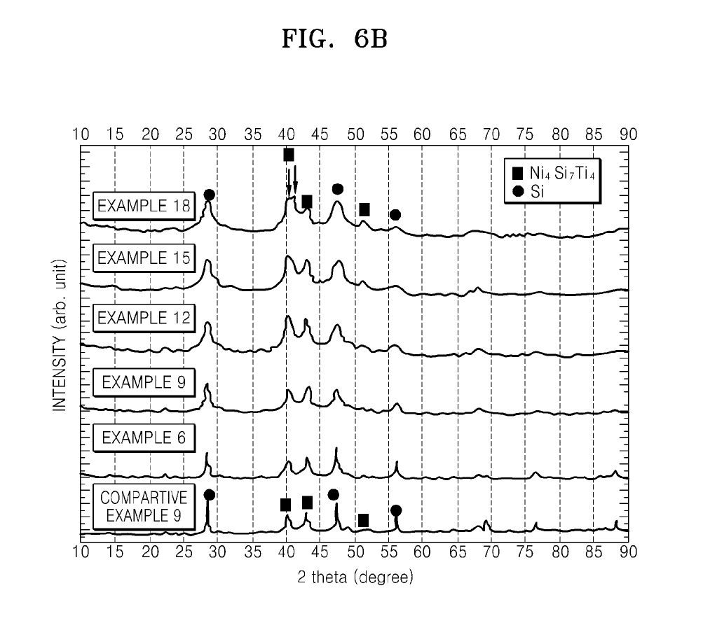

FIGS. 7A to 7C are graphs illustrating electrochemical performance of the negative active material powder that is milled and finely alloyed by mechanical alloying according to illustrative examples of the present invention.

In detail, FIG. 7A shows charging/discharging efficiency of negative active material powders according to embodiments of the present invention during cycle tests, FIG. 7B shows discharging capacitance of negative active material powders according to embodiments of the present invention during cycle tests, and FIG. 7C shows initial efficiency of negative active material powders and a capacity retention ratio during 52 cycle. FIGS. 7A to 7C shows lifespan characteristics of the negative active material powders of Examples 2, 5, 8, 11, 14, and 17 in which 15 wt % of nickel, 15 wt % of titanium, and the balance of silicon were included (that is, 70Si-15Ni-15Ti), and high energy milling was performed for 0.5, 1, 2, 4, 6 and 8 hours, and lifespan characteristics of the negative active material of Comparative Example 8, in which ball milling was performed. In addition, values of electrochemical characteristics are shown in Table 4 below.

Referring to FIGS. 7A to 7C, the negative active material powders of Examples 2, 5, 8, 11, 14, and 17 had a capacity retention ratio of 82.8% to 100%, whereas the negative active material powder of Comparative Example 8 had a capacity retention ratio of about 74.4%. Accordingly, it was confirmed that the negative active material powders of Examples 2, 5, 8, 11, 14, and 17 have excellent lifespan characteristics compared to the negative active material powder of Comparative Example 8.

In particular, regarding Examples 2, 5, 8, 11, 14, and 17, when a high energy milling process time increases, the capacity retention ratio gradually increases and the initial discharging capacitance decreases. This is because as the duration of mechanical alloying using the high energy milling increases, the silicon single phase is more uniformly and more finely fragmented in the negative active material powder, and thus, when charging/discharging are repeatedly performed, occurrence of stress caused by volumetric change of the silicon single phase may be effectively suppressed. On the other hand, the average grain size of the silicon single phase decreases as the duration of high energy milling increases. Accordingly, the surface area of the silicon single phase that may act as an active region for charging/discharging may decrease, and thus, initial discharging capacitance may decrease. Considering the trade-off relationship between the capacity retention ratio and the initial discharging capacitance, the high energy milling process may be performed for about 4 hours to 6 hours. That is, in the case of Examples 11 and 14 in which mechanical alloying is performed by high energy milling for 4 hours and 6 hours, respectively, the negative active material powders had excellent initial discharging capacitance, and an excellent capacity retention ratio of 95.9% and 99.1%.

TABLE 4

| | | 52 cycle | | Capacity |
|---|---|---|---|---|
| | Initial | Capacitance | Coulombic | retention |
| Sample No. | efficiency (%) | (mAh/g) | Efficiency (%) | ratio (%) |
| Example 2 | 87.1 | 852 | 98.5 | 82.8 |
| Example 5 | 87.9 | 960 | 99.1 | 93.9 |
| Example 8 | 87.8 | 984 | 99.6 | 96.9 |
| Example 11 | 86.0 | 842 | 99.1 | 95.9 |
| Example 14 | 85.6 | 860 | 99.3 | 99.1 |
| Example 17 | 83.3 | 796 | 99.2 | 100 |
| Comparative | 85.2 | 725 | 98.1 | 74.4 |
| Example 8 | | | | |

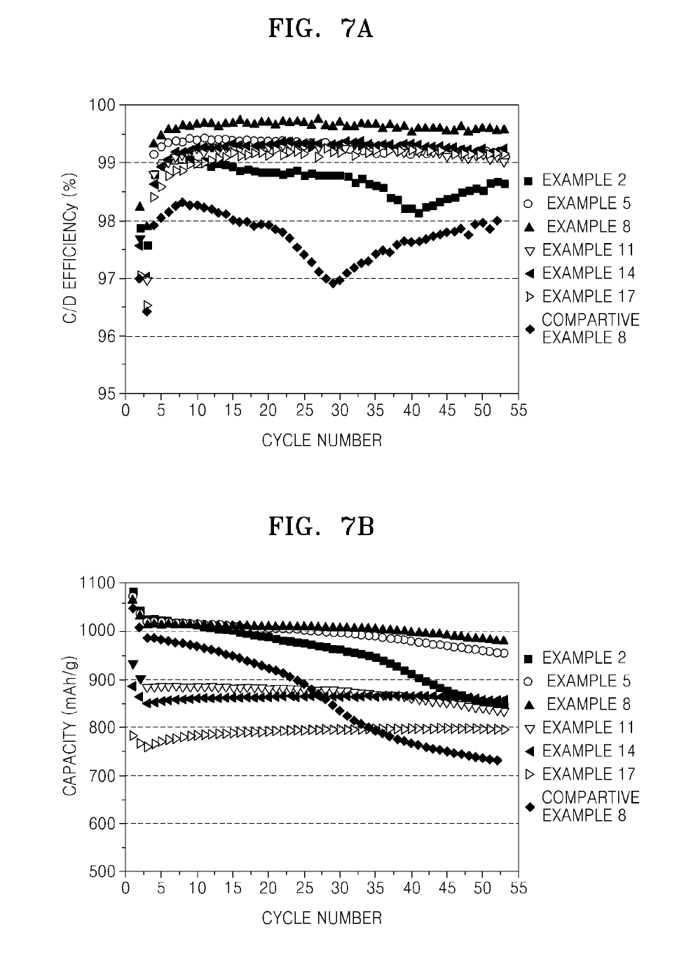

FIGS. 8 to 10 are graphs illustrating electrochemical performance of the negative active material powder that is milled and finely alloyed by mechanical alloying according to illustrative examples of the present invention.

FIG. 8 shows lifespan characteristics, i.e., capacity retention ratio, of the negative active material powders of Examples 1, 4, 7, 10, 13, and 16 in which 16 wt % of nickel, 16 wt % of titanium, and the balance of silicon were included (that is, 68Si-16Ni-16Ti), and high energy milling was performed for 0.5, 1, 2, 4, 6, and 8 hours, and lifespan characteristics of the negative active material of Comparative Example 7, in which ball milling was performed.

Referring to FIG. 8 and Table 5 below, as the high energy milling time increases, initial efficiency gradually decreases, while the capacity retention ratio gradually increases. In the case of all examples in which high energy milling was performed except for Example 1, the negative active material powders had higher initial efficiency and capacity retention ratio than that of Comparative Example 7.

TABLE 5

| | | 52 cycle | | Capacity |
|---|---|---|---|---|
| | Initial | Capacitance | Coulombic | retention |
| Sample No. | efficiency (%) | (mAh/g) | Efficiency (%) | ratio (%) |
| Example 1 | 85.2 | 782 | 99.1 | 86.3 |
| Example 4 | 86.1 | 859 | 98.8 | 94.5 |
| Example 7 | 85.2 | 865 | 99.2 | 94.8 |
| Example 10 | 84.6 | 862 | 99.5 | 95.2 |
| Example 13 | 84 | 759 | 99.6 | 98.7 |
| Example 16 | 81.2 | 752 | 99.2 | 100 |
| Comparative | 80.9 | 736 | 98.9 | 91.7 |
| Example 7 | | | | |

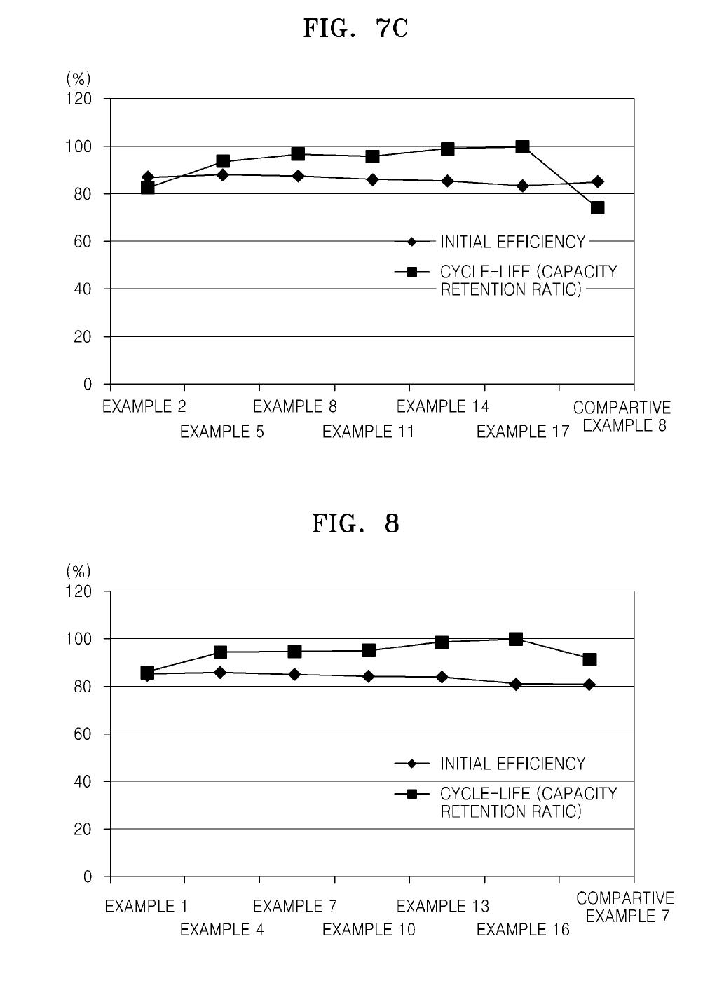

FIG. 9 shows lifespan characteristics of the negative active material powders of Examples 3, 6, 9, 12, 15, and 18 in which 14 wt % of nickel, 14 wt % of titanium, and the balance of silicon were included (that is, 72Si-14Ni-14Ti)), and high energy milling was performed for 0.5, 1, 2, 4, 6, and 8 hours, and lifespan characteristics of the negative active material of Comparative Example 9, in which ball milling was performed.

Referring to FIG. 9 and Table 6 below, as the high energy milling time increases, initial efficiency gradually decreases, while the capacity retention ratio gradually increases. In the case of examples in which high energy milling was performed, the negative active material powders had higher initial efficiency and capacity retention ratio than that of Comparative Example 9.

TABLE 6

| | | 52 cycle | | Capacity |
|---|---|---|---|---|
| | Initial | Capacitance | Coulombic | retention |
| Sample No. | efficiency (%) | (mAh/g) | Efficiency (%) | ratio (%) |
| Example 3 | 89.2 | 876 | 98.1 | 81.2 |
| Example 6 | 88.2 | 943 | 99.2 | 93.7 |
| Example 9 | 88 | 980 | 99.3 | 95.2 |
| Example 12 | 86.4 | 984 | 99 | 95.4 |
| Example 15 | 85.6 | 932 | 99.1 | 97.2 |
| Example 18 | 84.6 | 892 | 99.1 | 99.8 |
| Comparative | 86.2 | 732 | 97.5 | 72.3 |
| Example 9 | | | | |

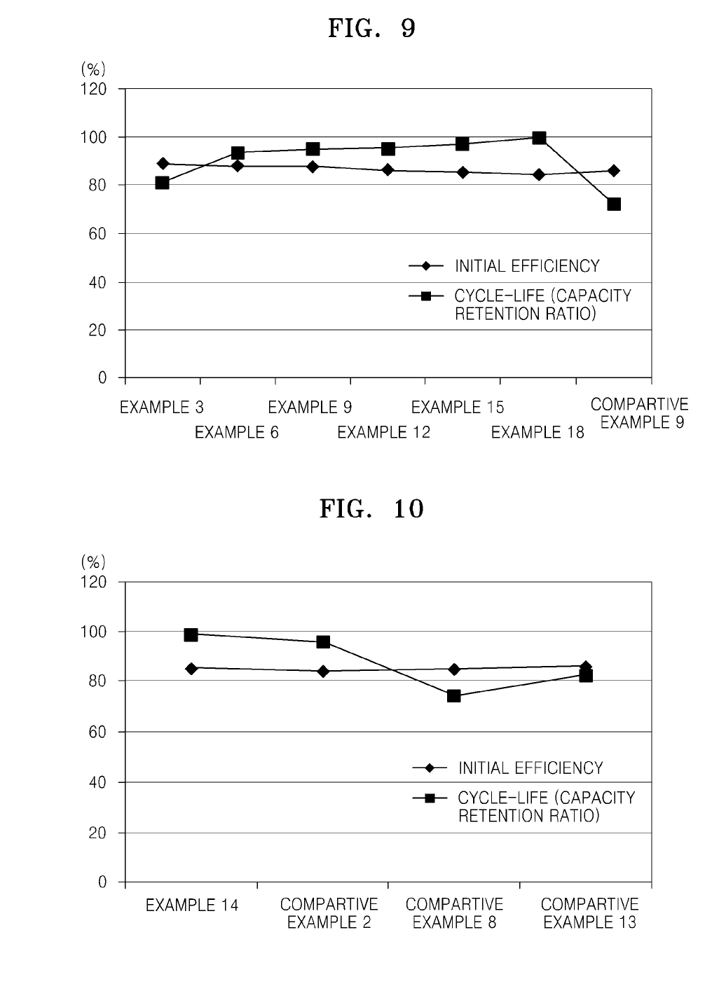

FIG. 10 shows lifespan characteristics test results of the negative active material powders that were prepared by high energy milling (Example 14), pebble milling (Comparative Example 2), low energy ball milling (Comparative Example 8), or attrition milling (Comparative Example 13), when 15 wt % of nickel, 15 wt % of titanium and the balance of silicon were included (corresponding to 70Si-15Ni-15Ti).

Referring to FIG. 10 and Table 7 below, it was confirmed that negative active material powder obtained by high energy milling, which corresponds to Example 14, excellent initial efficiency and capacity retention ratio were obtained.

TABLE 7

| | | 52 cycle | | Capacity |
|---|---|---|---|---|
| | Initial | Capacitance | Coulombic | retention |
| Sample No. | efficiency (%) | (mAh/g) | Efficiency (%) | ratio (%) |
| Example 14 | 85.6 | 794 | 99.3 | 99.1 |
| Comparative | 84.5 | 777 | 99.4 | 95.9 |
| Example 2 | | | | |
| Comparative | 85.2 | 725 | 98.1 | 74.4 |
| Example 8 | | | | |
| Comparative | 86.2 | 745 | 98.4 | 82.8 |
| Example 13 | | | | |

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A negative active material comprising:
a silicon single phase; and
a silicon-metal alloy phase by which the silicon single phase is bounded,
wherein the negative active material comprises 5 to 30 wt % of nickel, 5 to 30 wt % of titanium, and 40 to 90 wt % of silicon,
the negative active material has a first peak of the silicon-metal alloy phase in an X-ray diffraction analysis spectrum,
the silicon single phase is finely distributed in the silicon-metal single phase by mechanical alloying, and
the first peak resulting from the (501) surface of the silicon-metal alloy phase has a greater value than the first peak resulting from the (501) surface of the silicon-metal alloy phase that is not subjected to the mechanical alloying, by 0.6° to 0.9°.

2. The negative active material of claim 1, wherein the first peak results from a (501) surface of Ni₄Si₇Ti₄ and appears at 40.3±0.15 degrees (°).

3. The negative active material of claim 1, wherein
the first peak resulting from the (501) surface of the silicon-metal alloy phase has a greater value than the first peak resulting from the (501) surface of the silicon-metal alloy phase that is not subjected to the mechanical alloying, by 0.7° to 0.8°.

4. The negative active material of claim 1, wherein
the first peak resulting from the (501) surface of the silicon-metal alloy phase shifts more on the right hand side in X-ray diffraction analysis spectrum than the first peak resulting from the (501) surface of the silicon-metal alloy phase that is not subjected to the mechanical alloying by 0.6° to 0.9°, due to shrinking of a lattice in a direction perpendicular to the (501) surface by performing mechanical alloying comprising high energy milling.

5. The negative active material of claim 1, wherein
the first peak resulting from the (501) surface of the silicon-metal alloy phase shifts more on the right hand side in X-ray diffraction analysis spectrum than the first peak resulting from the (501) surface of the silicon-metal alloy phase that is not subjected to the mechanical alloying by 0.7° to 0.8°, due to shrinking of a lattice in a direction perpendicular to the (501) surface by performing mechanical alloying comprising high energy milling.

6. The negative active material of claim 1, wherein
the negative active material comprises 10 to 30 wt % of nickel, 10 to 30 wt % of titanium, and 40 to 80 wt % of silicon.

7. The negative active material of claim 1, wherein
a size of the silicon single phase obtained from the X-ray diffraction analysis spectrum is smaller than 20 nm.

8. The negative active material of claim 1, wherein the negative active material further has a second peak of the silicon-metal alloy phase in an X-ray diffraction analysis spectrum.

9. The negative active material of claim 8, wherein the second peak results from a (501) surface of Ni₄Si₇Ti₄ and appears at 40.83±0.1 degrees (°).

10. A method of preparing a negative active material that is used in a secondary battery and comprises a silicon-metal alloy powder,
melting silicon and metal to form a molten mixture;
solidifying the molten mixture by rapid cooling to form a ribbon-shape rapid cooling solidification product; and
milling the rapid cooling solidification product by using a high energy milling apparatus so that alloy powder is formed and simultaneously, a silicon single phase is fragmented in the alloy powder,
wherein a size of the silicon single phase in the alloy powder is smaller than 50 nm.

11. The method of claim 10, wherein
the high energy milling apparatus comprises at least one selected from a high energy ball mill apparatus, an agitating ball mill apparatus, an oil-based ball mill apparatus, and a vibration ball mill apparatus.

12. The method of claim 10, wherein
the milling the rapid cooling solidification product by using a high energy milling apparatus is performed for 4 to 6 hours.
